(19) United States
(12) Patent Application Publication
(10) Pub. No.: US 2023/0341990 A1
(43) Pub. Date: Oct. 26, 2023

(54) VISUAL CONTENT GENERATING METHOD, HOST, AND COMPUTER READABLE STORAGE MEDIUM

(71) Applicant: HTC Corporation, Taoyuan City (TW)

(72) Inventor: Si-Huai Kuo, Taoyuan City (TW)

(73) Assignee: HTC Corporation, Taoyuan City (TW)

(21) Appl. No.: 17/894,136

(22) Filed: Aug. 23, 2022

Related U.S. Application Data
(60) Provisional application No. 63/332,697, filed on Apr. 20, 2022.

(51) Int. Cl. G06F 3/04815; G06F 3/04845; G06T 19/20

(52) U.S. Cl. CPC G06F 3/04815; G06F 3/04845; G06T 19/20; G06F 2203/04804; G06T 2200/24; G06T 2219/028; G06T 2219/2012

(57) ABSTRACT

The embodiments of the disclosure provide a visual content generating method, a host, and a computer readable storage medium. The method includes: obtaining a first eye image rendered by a 2D editor application, wherein the first eye image shows a virtual environment of a reality service; obtaining a screen view image of the 2D editor application, wherein the screen view image shows an editing interface of the 2D editor application editing the virtual environment; generating a visual content via overlaying the screen view image onto the first eye image, wherein the visual content includes a first content area and a second content area respectively corresponding to the first eye image and the screen view image, and the first content area is synchronized with the second content area.

### CROSS-REFERENCE TO RELATED APPLICATION

This application claims the priority benefit of U.S. provisional application Ser. No. 63/332,697, filed on Apr. 20, 2022. The entirety of the above-mentioned patent application is hereby incorporated by reference herein and made a part of this specification.

### BACKGROUND

### 1. Field of the Invention

The disclosure generally relates to an image processing technology, in particular, to a visual content generating method, a host, and a computer readable storage medium.

### 2. Description of Related Art

Conventionally, a designer can use 2D editor application on a computing device to design 3D objects/environments, such as the virtual objects/environments of a virtual reality (VR) service. However, if the designer wants to check the visual effects of the design result, the designer needs to control the 2D editor application to render the designed 3D objects/environments and put on a head-mounted display (HMD) to see the rendered objects/environments shown by the HMD.

After wearing the HMD, if the designer wants to modify the 3D objects/environments, the designer needs to take off the HMD and use the 2D editor application on the computing device.

Therefore, the designer needs to repeatedly put on and take off the HMD during designing the 3D objects/environments, which is an inconvenient way of use.

### SUMMARY OF THE INVENTION

Accordingly, the disclosure is directed to a visual content generating method, a host, and a computer readable storage medium, which may be used to solve the above technical problems.

The embodiments of the disclosure provide a visual content generating method, adapted to a host. The method includes: obtaining a first eye image rendered by a 2D editor application, wherein the first eye image shows a virtual environment of a reality service; obtaining a screen view image of the 2D editor application, wherein the screen view image shows an editing interface of the 2D editor application editing the virtual environment; generating a visual content via overlaying the screen view image onto the first eye image, wherein the visual content includes a first content area and a second content area respectively corresponding to the first eye image and the screen view image, and the first content area is synchronized with the second content area.

The embodiments of the disclosure provide a host including a storage circuit and a processor. The storage circuit stores a program code. The processor is coupled to the storage circuit and accessing the program code to perform: obtaining a first eye image rendered by a 2D editor application, wherein the first eye image shows a virtual environment of a reality service; obtaining a screen view image of the 2D editor application, wherein the screen view image shows an editing interface of the 2D editor application editing the virtual environment; generating a visual content via overlaying the screen view image onto the first eye image, wherein the visual content includes a first content area and a second content area respectively corresponding to the first eye image and the screen view image, and the first content area is synchronized with the second content area.

The embodiments of the disclosure provide a computer readable storage medium, the computer readable storage medium recording an executable computer program, the executable computer program being loaded by a host to perform steps of: obtaining a first eye image rendered by a 2D editor application, wherein the first eye image shows a virtual environment of a reality service; obtaining a screen view image of the 2D editor application, wherein the screen view image shows an editing interface of the 2D editor application editing the virtual environment; generating a visual content via overlaying the screen view image onto the first eye image, wherein the visual content includes a first content area and a second content area respectively corresponding to the first eye image and the screen view image, and the first content area is synchronized with the second content area.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a host according to an embodiment of the disclosure.

FIG. 2 shows a flow chart of the visual content generating method according to an embodiment of the disclosure.

FIG. 3 shows an application scenario according to an embodiment of the disclosure.

FIG. 4 shows a schematic diagram of adjusting the transparency of the screen view image according to an embodiment of the disclosure.

FIG. 5 shows an application scenario according to an embodiment of the disclosure.

FIG. 6 shows an application scenario according to another embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

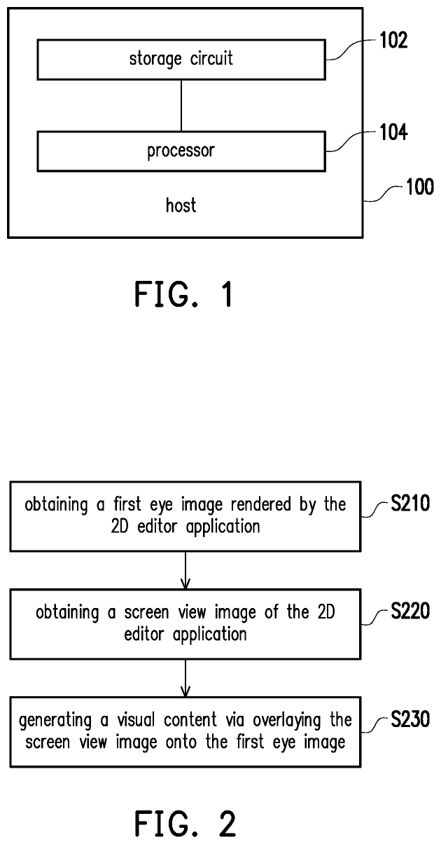

See FIG. 1, which shows a schematic diagram of a host according to an embodiment of the disclosure. In various embodiments, the host 100 can be any device capable of performing image processing functions, such as smart devices and/or computer devices, etc.

In the embodiments of the disclosure, the host 100 can be an HMD for providing reality services to the user thereof, wherein the reality services include, but not limited to, a virtual reality (VR) service, an augmented reality (AR) service, an extended reality (XR), and/or a mixed reality (MR), etc. In these cases, the host 100 can show the corresponding visual contents for the user to see, such as VR/AR/XR/MR visual contents.

In FIG. 1, the host 100 includes a storage circuit 102 and a processor 104. The storage circuit 102 is one or a combination of a stationary or mobile random access memory (RAM), read-only memory (ROM), flash memory, hard disk, or any other similar device, and which records a plurality of modules and/or program codes that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In the embodiments of the disclosure, the processor 104 may access the modules and/or program codes stored in the storage circuit 102 to implement the visual content generating method provided in the disclosure.

In the embodiments of the disclosure, the proposed method can generate a visual content that includes a first content area and a second content area, wherein the first content area corresponds to the virtual environment designed by the user via the 2D editor application run on a computing device, and the second content area shows an editing interface of the 2D editor application. Accordingly, the user can directly check both of the 2D editor application and the visual effect of the designed virtual environment in the visual content (e.g., a VR content shown by the HMD). In this case, the user does not need to repeatedly put on and take off the HMD, and the convenience of use can be improved. Details of the proposed method would be further discussed in the following.

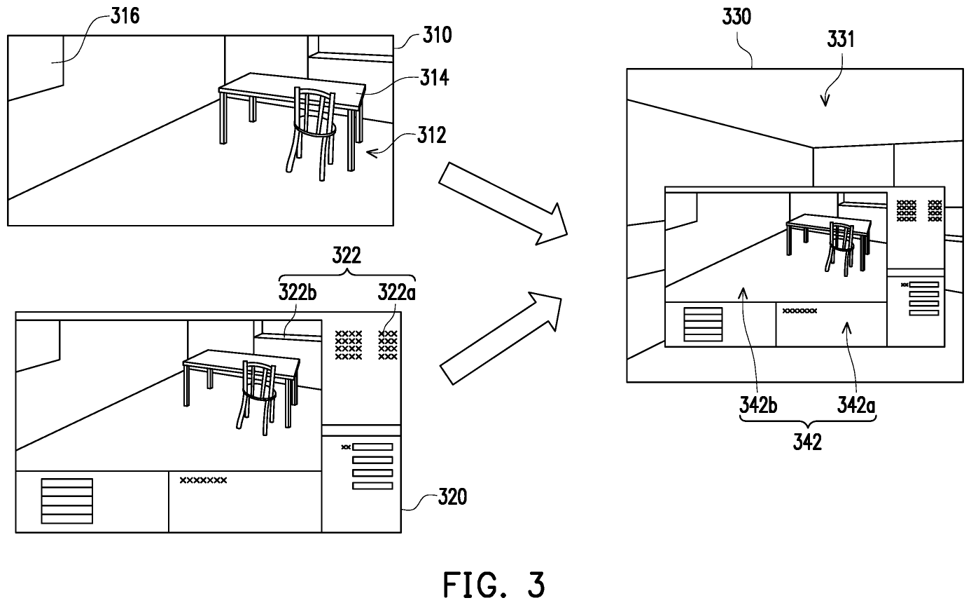

See FIG. 2, which shows a flow chart of the visual content generating method according to an embodiment of the disclosure. The method of this embodiment may be executed by the host 100 in FIG. 1, and the details of each step in FIG. 2 will be described below with the components shown in FIG. 1. For better explaining the concept of the disclosure, FIG. 3 would be used as an example, wherein FIG. 3 shows an application scenario according to an embodiment of the disclosure.

In step S210, the processor 104 obtains a first eye image 310 rendered by the 2D editor application, wherein the first eye image 310 shows a virtual environment 312 of a reality service. In the following embodiments, the VR service would be assumed to be the reality service provided by the host 100, but the concept of the disclosure can be applied to other kinds of reality services.

In one embodiment, the first eye image can be one of a left-eye image and a right-eye image rendered by the 2D editor application based on the virtual environment 312 currently designed by the user. Since the reality service is the VR service, the first eye image 312 can be understood as a VR image. In the embodiments of the disclosure, the introduced mechanism in the following can be also applied to a second eye image rendered by the 2D editor application, wherein the second eye image (e.g., another VR image) can be another of the left-eye image and the right-eye image, but the disclosure is not limited thereto.

In one embodiment, the 2D editor application can be run on the computing device (e.g., a computer), and the user can edit the virtual environment 312 by using the 2D editor application via operating the computing device and/or the host 100.

That is, the user can design the virtual environment 312 via the 2D editor application, and the 2D editor application on the computing device can accordingly render the first eye image 310 (and the second eye image) and provide the first eye image 310 (and the second eye image) to the host 100.

In various embodiments, the host 100 can be connected with the computing device via any wired/wireless communication protocol, and the first eye image 310 (and the second eye image) can be transmitted to the host 100 via the used wired/wireless communication protocol.

In step S220, the processor 104 obtains a screen view image 320 of the 2D editor application. In one embodiment, the computing device can stream or capture a screen snapshot of 2D editor application, render the screen snapshot of 2D editor application as the screen view image 320, and provide the screen view image 320 to the host 100. In this case, the processor 104 can obtain the screen view image 320 via receiving the screen view image 320 from the computing device.

In another embodiment, the computing device can transmit the screen snapshot of the 2D editor application and provide the screen snapshot of the 2D editor application to the host 100. In this case, the processor 104 can obtain the screen view image 320 via rendering the screen snapshot of 2D editor application as the screen view image 320.

In the embodiment, the screen view image 320 is also an image used in the reality service, i.e., a VR image.

In FIG. 3, the screen view image 320 shows an editing interface 322 of the 2D editor application editing the virtual environment 312, wherein the editing interface 322 includes a control panel 322a and an editing window 322b for showing the virtual environment 312. In one embodiment, the control panel 322a may include various function buttons of the 2D editor application for editing the virtual environment 312 shown in the editing window 322b.

Since the first eye image 310 is rendered based on the virtual environment 312 edited by the 2D editor application, the scene shown in the editing window 322b corresponds to the scene in the first eye image 310 rendered based on the virtual environment 312 edited in the editing window 322b.

In step S230, the processor 104 generates a visual content 330 via overlaying the screen view image 320 onto the first eye image 310. In FIG. 3, the visual content 330 includes a first content area 331 and a second content area 342 respectively corresponding to the first eye image 310 and the screen view image 320, and the first content area 331 is synchronized with the second content area 342.

In detail, since the first eye image 310 is rendered based on the virtual environment 312 edited in the 2D editor application, once the virtual environment 312 edited in the editing window 322b is changed, the first eye image 310 and the screen view image 320 would be accordingly and simultaneously changed, which leads to the synchronization between the first content area 331 and the second content area 342.

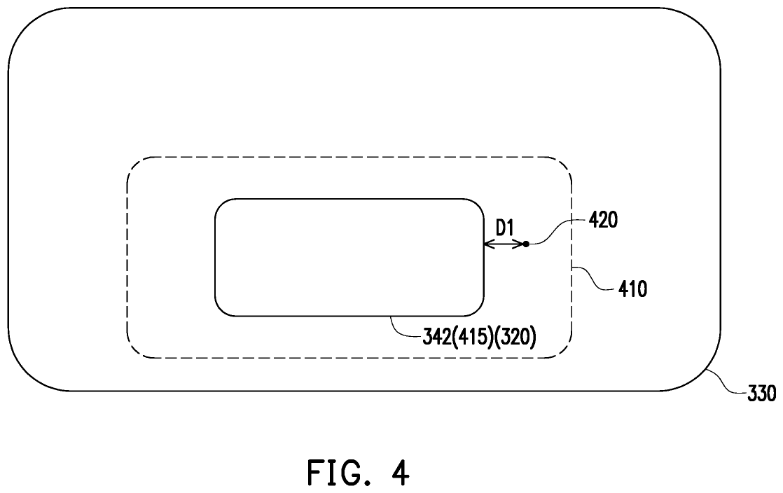

In FIG. 4, the second content area 342 includes a first sub-content area 342a and a second sub-content area 342b respectively corresponding to the control panel 322a and the editing window 322b. Since the second sub-content area 342b and the first content area 331 are both corresponding to the virtual environment 312 edited in the 2D editor application, the synchronization between the first content area 331 and the second content area 342 can be understood as the synchronization between the first content area 331 and the second sub-content area 342b (i.e., the second sub-content area 342b is synchronized with the first content area 331 in the visual content 330), but the disclosure is not limited thereto.

In the embodiment, the visual content 330 can be the VR content shown by the host 100 (e.g., the HMD) to the user. Accordingly, the user can directly check the visual effect of the designed virtual environment without repeatedly putting on and taking off the HMD, which improves the convenience of use.

In one embodiment, the virtual environment 312 includes a user representative object moved in response to a movement of the host 100. In the embodiment, the processor 104 can obtains a viewing angle corresponding to the user representative object and a relative position between the user representative object and the virtual environment 312, and accordingly adjust the first content area 331 and the second content area 342 in the visual content 330. Taking FIG. 4 as an example, if the user wearing the host 100 (e.g., the HMD) walks forward, the user representative object would be accordingly moved forward, and the processor 104 can adjust the first content area 331 by, for example, zooming in the scene in the virtual environment to make the user feel like being approaching, for example, the desk 314 in the virtual environment 312. For another example, if the user wearing the host 100 (e.g., the HMD) turns the head thereof to the left, the viewing angle of the user representative object would be accordingly turned to the left, and the processor 104 can adjust the first content area 331 by, for example, showing the scene on the left of the user representative object in the virtual environment to make the user feel like being facing, for example, the TV 316 in the virtual environment 312.

Since the first content area 331 has been adjusted based on the viewing angle corresponding to the user representative object and the relative position between the user representative object and the virtual environment 312, the processor 104 can accordingly synchronize editing window 322b and (the second sub-content 322b) of the second content area 342 with the adjusted first content area 331, but the disclosure is not limited thereto.

In one embodiment, the user can operate the 2D editor application via interacting with the visual content 330, which further improves the convenience of use. Detailed discussion would be provided in the following.

In one embodiment, the host 100 can be connected with an input device, such as a mouse, and use the mouse to interact with the second content area 342 to correspondingly operate the 2D editor application.

In one embodiment, the processor 104 can provide a cursor corresponding to the input device in the visual content 330 and obtain a cursor position of the cursor in the visual content 330.

In a first embodiment, in response to determining that the cursor position is within the second content area 342, the processor 104 can control the 2D editor application based on a first interaction between the cursor and the second content area 342.

In the first embodiment, in response to determining that an input event of the input device is detected at a first position in the second content area 342, the processor 104 can accordingly provide a first control signal to the computing device. In the embodiment, the first control signal may indicate the input event and a second position in the editing interface 322, and the first control signal controls the computing device to operate the 2D editor application based on the input event and the second position. In the first embodiment, the relative position between the first position and the second content area 342 corresponds to the relative position between the editing interface 322 and the second position.

For example, if the user uses the cursor of the input device to trigger a specific button shown on the top-left corner in the second content area 342, the processor 104 may determine the behavior of the user triggering the specific button as the input event and obtain the corresponding cursor position in the second content area 342 as the first position. Next, the processor 104 can determine the corresponding second position in the editing interface 322 based on the relative position between the first position and the second content area 342, and generate the first control signal.

After the computing device receives the first control signal, the computing device can accordingly operate the 2D editor application in the way of the user triggering the specific button on the top-left corner in the editing interface 322, but the disclosure is not limited thereto.

In a second embodiment, after obtaining the cursor position of the cursor in the visual content, the processor 104 can further determine whether the cursor position is within the first content area 331.

In the second embodiment, in response to determining that the cursor position is within the first content area 331, the processor 104 can adjust the virtual environment edited in the editing interface 322 of the 2D editor application based on a second interaction between the cursor and the first content area 331.

In the second embodiment, in response to determining that an input event of the input device is detected at a third position in the first content area 331, the processor 104 can accordingly provide a second control signal to the computing device. In the embodiment, the second control signal may indicate the input event and a fourth position in the editing window 322b, and the second control signal controls the computing device to operate the virtual environment 312 shown in the editing window 322b based on the input event and the fourth position. In the embodiment, the relative position between the third position and the first content area 331 corresponds to the relative position between the editing window 322b and the fourth position.

For example, if the user uses the cursor of the input device to click a virtual object shown in the first content area 331, the processor 104 may determine the behavior of the user clicking the virtual object as the input event and obtain the corresponding cursor position in the first content area 331 as the third position. Next, the processor 104 can determine the corresponding fourth position in the editing window 322b based on the relative position between the third position and the first content area 331, and generate the second control signal.

After the computing device receives the second control signal, the computing device can accordingly operate the 2D editor application in the way of the user clicking the virtual object in the editing window 322a, but the disclosure is not limited thereto.

Based on the above, the user can, for example, move/rotate any virtual object in the editing window 322a by performing the corresponding interactions with the first content area 331, but the disclosure is not limited thereto.

Accordingly, the convenience of the user operating the 2D editor application can be further improved.

See FIG. 4, which shows a schematic diagram of adjusting the transparency of the screen view image according to an embodiment of the disclosure. In FIG. 4, the processor 104 determines a detecting area 410 surrounding a specific area 415 for showing the second content area 342 in the visual content 330. In one embodiment, the detecting area 410 can be visible/invisible to the user.

Next, the processor 104 can provide a cursor 420 corresponding to the input device in the visual content 330 and obtain a cursor position of the cursor 420 in the visual content 330.

In the embodiment, in response to determining that the cursor position is within the detecting area 410, the processor 104 can adjust a transparency of the screen view image 320 before overlaying the screen view image 320 onto the first eye image 310.

In one embodiment, the transparency of the screen view image 320 (which corresponds to the second content area 342) can be positively related to a distance D1 between the cursor position in the detecting area 410 and the specific area 415. That is, when the cursor 420 in the detecting area 410 is getting further from the specific area 415, the transparency of the screen view image 320 would be higher, which makes the second content area 342 more and more transparent. On the other hand, when the cursor 420 in the detecting area 410 is getting closer to the specific area 415, the transparency of the screen view image 320 would be lower, which makes the second content area 342 less transparent.

In one embodiment, in response to determining that the cursor position is within the specific area 415, the processor 104 can determine the transparency of the screen view image 320 to be a first transparency (e.g., 0%). In addition, in response to determining that the cursor position is outside of the detecting area 410, the processor 104 can determine the transparency of the screen view image 320 to be a second transparency (e.g., 100%), wherein the second transparency is higher than the first transparency.

In this case, when the user moves the cursor 420 closer to the specific area 415, the user can see a less transparent second content area 342 in the visual content 330. On the other hand, when the user moves the cursor 420 away from the specific area 415, the user can see a more transparent second content area 342 in the visual content 330. In one embodiment, when the cursor 420 is outside of the detecting area 410-, the second content area 342 can be even invisible in the visual content 330 for not blocking the vision of the user seeing the first content area 331 (which corresponds to the designed virtual environment 312).

From another perspective, the second content area 342 can be shown in the visual content 330 when the user needs to operate the 2D editor application. Accordingly, the operating experience of the user can be improved.

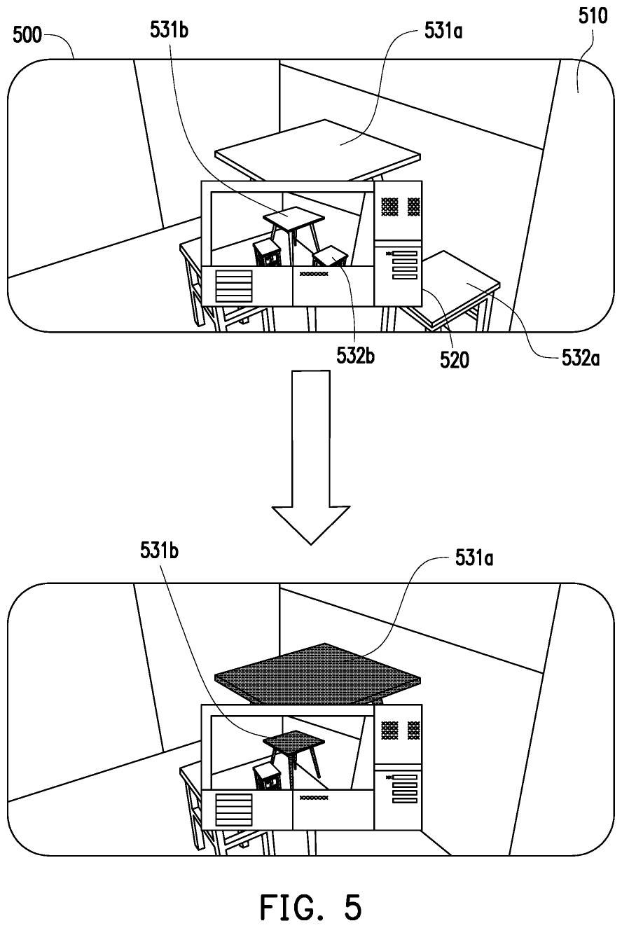

See FIG. 5, which shows an application scenario according to an embodiment of the disclosure. In FIG. 5, it is assumed that the host 100 shows the visual content 500 for the user to see, wherein the visual content 500 includes a first content area 510 and a second content area 520. In the embodiment, the first content area 510 shows the 3D virtual environment edited in the 2D editor application, whose editing interface is shown in the second content area 520.

In the embodiment, the virtual embodiment may exemplarily include virtual objects 531a (e.g., a table) and 532a (e.g., a chair), and the editing window in the second content area 520 would include virtual objects 531b and 532b respectively corresponding to the virtual objects 531a and 532a.

In one embodiment, assuming that the user changes the color of the virtual object 531b to be black and removes the virtual object 532b via operating the editing interface of the 2D editor application, the color of the virtual object 531a in the first content area 510 would be correspondingly changed to be black, and the virtual object 532a would be disappeared from the first content area 510.

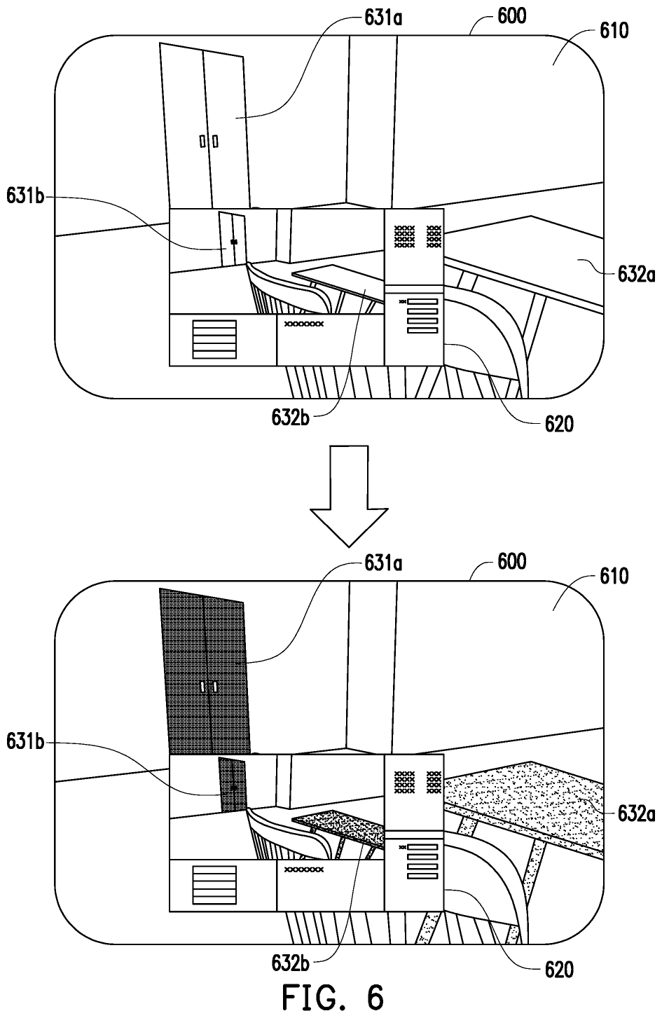

See FIG. 6, which shows an application scenario according to another embodiment of the disclosure. In FIG. 6, it is assumed that the host 100 shows the visual content 600 for the user to see, wherein the visual content 600 includes a first content area 610 and a second content area 620. In the embodiment, the first content area 610 shows the 3D virtual environment edited in the 2D editor application, whose editing interface is shown in the second content area 620.

In the embodiment, the virtual embodiment may exemplarily include virtual objects 631a (e.g., a door) and 632a (e.g., a table), and the editing window in the second content area 620 would include virtual objects 631b and 632b respectively corresponding to the virtual objects 631a and 632a.

In one embodiment, assuming that the user changes the color of the virtual object 631b to be gray and change the material of the virtual object 632b via operating the editing interface of the 2D editor application, the color of the virtual object 631a in the first content area 610 would be correspondingly changed to be gray, and the material of the virtual object 632a would be changed according to the setting in the 2D editor application.

The disclosure further provides a computer readable storage medium for executing the visual content generating method. The computer readable storage medium is composed of a plurality of program instructions (for example, a setting program instruction and a deployment program instruction) embodied therein. These program instructions can be loaded into the host 100 and executed by the same to execute the visual content generating method and the functions of the host 100 described above.

In summary, the embodiments of the disclosure can generate a visual content that includes a first content area and a second content area via overlaying the screen view image onto the first eye image, wherein the first content area corresponds to the virtual environment designed by the user via the 2D editor application run on a computing device, and the second content area shows an editing interface of the 2D editor application. Accordingly, the user can directly check both of the 2D editor application and the 3D visual effect of the designed virtual environment in the visual content (e.g., a VR content shown by the HMD). In this case, the user does not need to repeatedly put on and take off the HMD, and the convenience of use can be improved.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A visual content generating method, adapted to a host, comprising:
obtaining a first eye image rendered by a 2D editor application, wherein the first eye image shows a virtual environment of a reality service;
obtaining a screen view image of the 2D editor application, wherein the screen view image shows an editing interface of the 2D editor application editing the virtual environment;
generating a visual content via overlaying the screen view image onto the first eye image, wherein the visual content comprises a first content area and a second content area respectively corresponding to the first eye image and the screen view image, and the first content area is synchronized with the second content area.

2. The method according to claim 1, wherein the virtual environment comprises a user representative object moved in response to a movement of the host, and the method further comprises:
obtaining a viewing angle corresponding to the user representative object and a relative position between the user representative object and the virtual environment, and accordingly adjusting the first content area and the second content area in the visual content.

3. The method according to claim 1, wherein the editing interface of the 2D editor application comprises a control panel and an editing window for showing the virtual environment, and the second content area comprises a first sub-content area and a second sub-content area respectively corresponding to the control panel and the editing window, wherein the second sub-content area is synchronized with the first content area in the visual content.

4. The method according to claim 1, further comprising:
providing a cursor corresponding to an input device in the visual content;
obtaining a cursor position of the cursor in the visual content;
in response to determining that the cursor position is within the second content area, controlling the 2D editor application based on a first interaction between the cursor and the second content area.

5. The method according to claim 4, wherein the step of controlling the 2D editor application based on the first interaction between the cursor and the second content area comprises:
in response to determining that an input event of the input device is detected at a first position in the second content area, accordingly providing a first control signal to a computing device running the 2D editor application, wherein the first control signal indicates the input event and a second position in the editing interface, and the first control signal controls the computing device to operate the 2D editor application based on the input event and the second position.

6. The method according to claim 5, wherein a relative position between the first position and the second content area corresponds to a relative position between the editing interface and the second position.

7. The method according to claim 1, further comprising:
providing a cursor corresponding to an input device in the visual content;
obtaining a cursor position of the cursor in the visual content;
in response to determining that the cursor position is within the first content area, adjusting the virtual environment edited in the editing interface of the 2D editor application based on a second interaction between the cursor and the first content area.

8. The method according to claim 7, wherein the editing interface of the 2D editor application comprises a control panel and an editing window for showing the virtual environment, and the step of adjusting the virtual environment edited in the editing interface of the 2D editor application based on the second interaction between the cursor and the first content area comprises:
in response to determining that an input event of the input device is detected at a third position in the first content area, accordingly providing a second control signal to a computing device running the 2D editor application, wherein the second control signal indicates the input event and a fourth position in the editing window, and the second control signal controls the computing device to operate the virtual environment shown in the editing window based on the input event and the fourth position.

9. The method according to claim 7, wherein a relative position between the third position and the first content area corresponds to a relative position between the editing window and the fourth position.

10. The method according to claim 1, further comprising:
determining a detecting area surrounding a specific area for showing the second content area in the visual content;
providing a cursor corresponding to an input device in the visual content;
obtaining a cursor position of the cursor in the visual content;
in response to determining that the cursor position is within the detecting area, adjusting a transparency of the screen view image before overlaying the screen view image onto the first eye image.

11. The method according to claim 10, wherein the transparency of the screen view image is positively related to a distance between the cursor position in the detecting area and the specific area.

12. The method according to claim 10, further comprising:
in response to determining that the cursor position is within the specific area, determining the transparency of the screen view image to be a first transparency;
in response to determining that the cursor position is outside of the detecting area and the specific area, determining the transparency of the screen view image to be a second transparency, wherein the second transparency is higher than the first transparency.

13. The method according to claim 1, comprising:
receiving the first eye image from a computing device running the 2D editor application.

14. The method according to claim 1, comprising:
receiving, from a computing device running the 2D editor application, the screen view image rendered by the computing device.

15. The method according to claim 1, comprising:
receiving a screen snapshot from a computing device running the 2D editor application;
rendering the screen view image based on the screen snapshot.

16. A host, comprising:
a non-transitory storage circuit, storing a program code;
a processor, coupled to the non-transitory storage circuit and accessing the program code to perform:
obtaining a first eye image rendered by a 2D editor application, wherein the first eye image shows a virtual environment of a reality service;
obtaining a screen view image of the 2D editor application, wherein the screen view image shows an editing interface of the 2D editor application editing the virtual environment;
generating a visual content via overlaying the screen view image onto the first eye image, wherein the visual content comprises a first content area and a second content area respectively corresponding to the first eye image and the screen view image, and the first content area is synchronized with the second content area.

17. The host according to claim 16, wherein the host is a head-mounted display providing the reality service.

18. The host according to claim 16, wherein the host is connected with an input device, and the processor
providing a cursor corresponding to an input device in the visual content;
obtaining a cursor position of the cursor in the visual content;
in response to determining that the cursor position is within the second content area, controlling the 2D editor application based on a first interaction between the cursor and the second content area;
in response to determining that the cursor position is within the first content area, adjusting the virtual environment edited in the editing interface of the 2D editor application based on a second interaction between the cursor and the first content area.

19. The host according to claim 18, wherein the host is connected to a computing device running the 2D editor application, the editing interface of the 2D editor application comprises a control panel and an editing window for showing the virtual environment, and the processor performs:
in response to determining that an input event of the input device is detected at a first position in the second content area, accordingly providing a first control signal to the computing device, wherein the first control signal indicates the input event and a second position in the editing interface, and the first control signal controls the computing device to operate the 2D editor application based on the input event and the second position;
in response to determining that the input event of the input device is detected at a third position in the first content area, accordingly providing a second control signal to the computing device, wherein the second control signal indicates the input event and a fourth position in the editing window, and the second control signal controls the computing device to operate the virtual environment shown in the editing window based on the input event and the fourth position.

20. A non-transitory computer readable storage medium, the computer readable storage medium recording an executable computer program, the executable computer program being loaded by a host to perform steps of:
obtaining a first eye image rendered by a 2D editor application, wherein the first eye image shows a virtual environment of a reality service;
obtaining a screen view image of the 2D editor application, wherein the screen view image shows an editing interface of the 2D editor application editing the virtual environment;
generating a visual content via overlaying the screen view image onto the first eye image, wherein the visual content comprises a first content area and a second content area respectively corresponding to the first eye image and the screen view image, and the first content area is synchronized with the second content area.
